(19) United States
(12) Patent Application Publication
(10) Pub. No.: US 2024/0423766 A1
(43) Pub. Date: Dec. 26, 2024

(54) Dental Analog

(71) Applicant: Heinrich STEGER, Sand in Taufers (IT)

(72) Inventor: Heinrich STEGER, Sand in Taufers (IT)

(21) Appl. No.: 18/752,928

(22) Filed: Jun. 25, 2024

(30) Foreign Application Priority Data
Jun. 26, 2023 (EP) 23181575.4

(51) Int. Cl. A61C 13/34

(52) U.S. Cl. CPC A61C 13/34

(57) ABSTRACT

A dental analog including an installation section and an interface section located opposite to the installation section, with the installation section including an end section for inserting the dental analog into a cavity of a 3D model, where the installation section includes a locking section with expansion elements, and a locking element is provided, by way of which the expansion elements are pivotable out of the locking section and pivotable into the locking section.

The present invention relates to a dental analog comprising an installation section and an interface section located opposite to the installation section, wherein the installation section has an area, which preferably has a substantially cylindrical or conical design, for use in a 3D model. Furthermore, the invention relates to a method of producing dental prostheses. Finally, the invention relates to the use of dental analogs in a 3D model, in particular a 3D cast model, a 3D milled model or a 3D print model of a set of teeth.

### BACKGROUND OF THE INVENTION

Providing patients with dental prostheses requires careful planning of the entire process from the insertion of a dental implant into the jawbone to the design and installation of the finished artificial dental crown. In addition to inserting the dental implant into the jaw and osseointegration, the precise manufacture of the dental crown is the critical step for a successful result.

During the manufacture and modelling of the dental crown, 3D models of the teeth are used by means of which the actual situation in the mouth is recreated. According to the prior art, 3D models are manufactured using an imprint and model casting or using scanning and 3D printing or machining. In the 3D model, a so-called dental analog is used at the point to be taken care of in the real set of teeth. The dental analog is sometimes also referred to as a scan analog, a print analog, an analog or an implant analog. It is an aid in modelling the dental prosthesis, and, in the 3D model, it substitutionally assumes the function of the implant body within the set of teeth. In this way, a congruent situation of the real set of teeth can be created on the 3D model, since the dental analog simulates the implant body.

For modelling and adjusting the prosthesis, precise positioning of the dental analog in the 3D model is of utmost importance.

According to the prior the art, the installation section of the dental analog is inserted from above into an opening in the 3D model of the jaw and is attached to the 3D model from the backside or at a right angle to the insertion axis via a retaining screw. This procedure involves two disadvantages. On the one hand, the handling of inserting and positioning the dental analog in the 3D model is complex. Furthermore, precise positioning is hardly possible.

There are approaches to compensate for the latter disadvantage by means of surfaces that fit perfectly between the dental analog and the 3D model (e.g., flat spots, pins and a mortise), however, this is not sufficient, especially for 3D models produced by 3D printing. 3D printing is known for its lack of precision or, respectively, low accuracy. Therefore, in case of dental analogs according to the prior art which are in the assembled state, axial and rotational play always emerges between the dental analog and the 3D model. Even if the dental analog is attached from below by the fixing screw, it can be moved and shifted within the existing play, as the dental prosthesis is being assembled. The 3D model/dental analog assembly is changed by force and no longer correlates with the actual situation in the mouth. This naturally creates problems when finalizing the tooth restoration for the restoration in the mouth.

An alternative dental analog is described in EP 2 416 728 A1, which does not describe a two-part installation section but rather an installation section with a self-tapping external thread that is screwed into the 3D model and thus fastened. The dental analog of EP 2 416 728 A1 has a predetermined installation depth that is defined via the external thread. Furthermore, the force exerted on the dental analog during the modelling of the dental prosthesis occasionally causes loosening within the 3D model.

### SHORT DESCRIPTION OF THE INVENTION

It is the object of the present invention to provide a dental analog in which the above-mentioned disadvantages are diminished. In particular, the insertion of the dental analog into the 3D model should be simplified, and the positioning of the dental analog within the 3D model should be improved.

This object is achieved by a
dental analog comprising
an installation section and an interface section located opposite to the installation section,
with the installation section comprising an end section for inserting the dental analog into a cavity of a 3D model,
characterized in that
the installation section comprises a locking section with expansion elements,
wherein a locking element is provided, by means of which the expansion elements are pivotable out of the locking section and pivotable into the locking section.

A dental analog replicates the precise positioning and the connection between the dental prosthesis and the implant within the set of teeth on the 3D model. For this purpose, the installation section of the dental analog is inserted into a cavity in the 3D model of the set of teeth. The cavity in the 3D model is usually designed as a bore. Therefore, the installation section is preferably designed so as to be essentially cylindrical, at least in some areas, in order to facilitate the insertion of the dental analog into the cavity and to ensure that the dental analog is guided along the insertion axis. However, the installation section does not have to be designed in a cylindrical manner across the entire area. It can have, for example, several cylindrical areas and/or areas designed in different shapes. Ideally, however, a cylindrical (preferably circular cylindrical) area is provided in the region of the largest diameter of the installation section. This area stabilizes the dental analog in the cavity along the insertion axis.

In the end region, the installation section can have a conical design in some areas so as to enable easier insertion.

The installation section can be stably connected to the 3D model via the locking element and the locking section by extending the expansion elements from the locking section. This has the advantage that the installation section can be optimally positioned and automatically centered. In the installed state in the 3D model, the installation section thus provides maximum stability. The locking section itself can in turn have a cylindrical design.

In one embodiment variant, the locking element can be actuated in the axial direction of the dental analog from the side of the interface section. As a result, installation is possible without the need for handling from the underside of the 3D model. In one embodiment variant, the locking element can be actuated in the axial direction from the side opposite the interface section, which is advantageous for the front teeth in the set of teeth. In a preferred embodiment variant, the locking element is accessible from both sides-if necessary, two or more locking elements can also be provided.

The locking element can comprise a screw section, and the installation section can comprise a threaded section corresponding to the screw section. Furthermore, the locking element can be movable in the axial direction of the dental analog relative to the locking section. For example, via a conical contour of the locking element, force can thus be exerted on the expansion elements, which can be pivoted out from the locking section in such a way. Hence, the expansion elements can be designed such that they can be pivoted out radially along the longitudinal axis of the installation section.

The screw section and the corresponding threaded section can comprise a clamping screw by means of which a force can be exerted on the expansion elements. The clamping screw can be made accessible from one or both sides of the installation section.

The expansion elements can be pivoted out radially, for example, along the longitudinal axis of the installation section. This enables perfect expansion and a detachable connection between the 3D model and the installation section. The detachable connection can be configured in a non-positive and/or positive way. For soft 3D models, a positive connection is preferred. The installation section is thus immovable in the radial direction even in case of less precise 3D models. The expansion elements can comprise claws.

Preferably, the expansion elements, in the pivoted-out state, form, for example, the shape of a truncated cone, with the top surface of the truncated cone being arranged closer to the free-standing section than the base surface of the truncated cone. Slipping along the longitudinal axis is thereby practically ruled out.

To facilitate orientation and to eliminate confusion, the dental analogs can have codes. For example, the dental analogs can be pre-coloured in different ways. For instance, colour coding can be provided for different manufacturers, different abutments or different types of teeth.

Furthermore, the installation section can have a guide aid so that proper placement in the 3D model is ensured. For example, an index can be provided for this purpose. In the area of the expansion elements, a guide aid is preferably provided as a protruding index between two expansion elements. The guide aid can interact with a corresponding section in the 3D model (e.g., a groove or a projection) and can ensure the correct insertion of the dental analog along the insertion axis.

The installation section and the interface section can be designed as one piece.

In one embodiment variant, it is envisaged that the installation section and the interface section are detachably connected to each other via a connection. In this way, different interface sections can be used-depending on the employed manufacturer. Furthermore, such a two-part (or multi-part) structure of the dental analog allows different abutments or unprocessed dental crowns to be attached-depending on the installation situation and the geometry. Optionally, the installation section can be provided in a detached state from the interface section, and only the installation section can be inserted first. Subsequently, the interface section can be assembled to complete the dental analog.

The detachable connection between the installation section and the interface section can be formed in various ways. The detachable connection is preferably configured in a positive way. The correct fit of the interface section relative to the installation section can be ensured by positive locking.

However, the detachable connection between the installation section and the interface section can also be configured in a non-positive way, and, of course, it can be configured in a positive and non-positive way to achieve maximum stability.

The interface section usually comprises a holding device either for an abutment or for a dental prosthesis. In most cases, the interface section is also inserted to a large extent into the 3D model, and only a very small part protrudes from the 3D model.

The dental analog usually serves as an interface to the abutment (or the dental abutment), which acts as a connecting element between the implant body, which is firmly fused into the jawbone, and the actual dental prosthesis, which is attached to the top of the implant.

Occasionally, however, the dental crown is also placed directly on the implant without an abutment.

Furthermore, the invention relates to a method of producing a dental prosthesis for a set of teeth, characterized by the steps of:
(i) creating a 3D model of the set of teeth,
(ii) incorporating an opening in the 3D model in the area in which an implant for the dental prosthesis is provided in the set of teeth,
(iii) introducing the installation section of a dental analog of the above-mentioned type into the opening and locking the dental analog by actuating the locking element,
(iv) inserting an unprocessed dental crown into the interface section, with an abutment optionally being inserted beforehand between the interface section and the unprocessed dental crown,
(v) modelling the unprocessed dental crown to form the desired dental prosthesis, and
(vi) removing the finished dental prosthesis.

The 3D model of the set of teeth can be produced using an imprint and subsequently casting or using a dental scan and 3D printing or 3D milling.

### BRIEF DESCRIPTION OF THE DRAWINGS

Further advantages and details of the invention are explained on the basis of the figures and the description of the figures.

FIG. 1 shows a dental analog according to the invention in an oblique view.

FIGS. 2a, 2b, 2c show the dental analog of FIG. 1 in a top view (FIG. 2a) and in two sectional views along the axes A-A (FIG. 2b) and B-B (FIG. 2c).

FIG. 3a, 3b show the dental analog of FIG. 1 in an exploded view (FIG. 3a) including a cross-sectional view (FIG. 3b) of the exploded view along the axis A-A.

FIG. 4a, 4b show the dental analog of FIG. 1 with the expansion elements pivoted in (FIG. 4a) and, in the locked state, with the expansion elements pivoted out (FIG. 4b).

FIG. 5a, 5b show the dental analog of FIG. 1 (schematically) inserted into a 3D model (FIG. 5a) as well as a cross-section of the locking section (FIG. 5b).

### DETAILED DESCRIPTION OF THE INVENTION

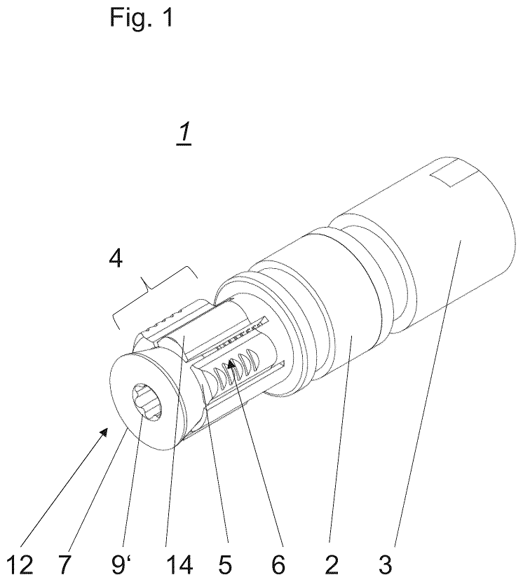

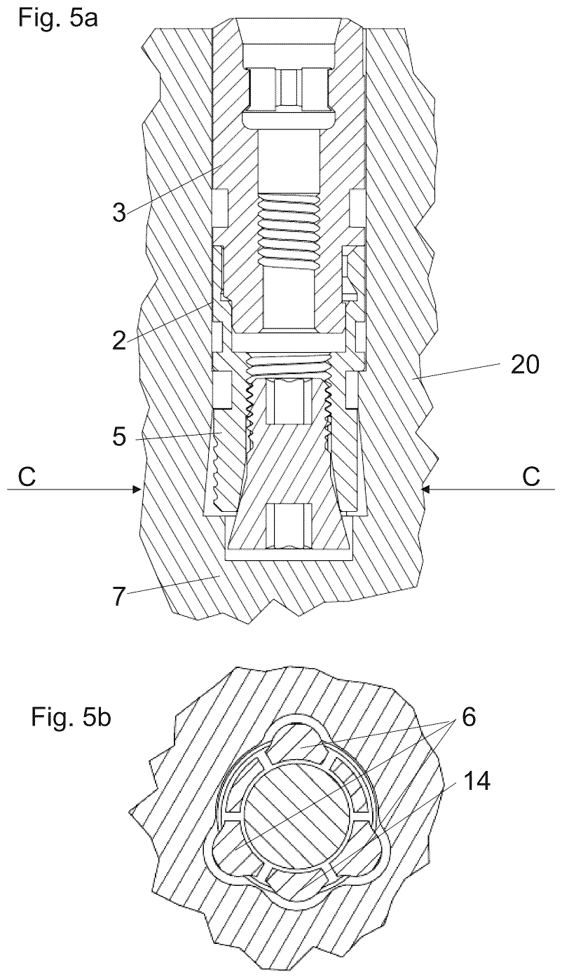

In FIG. 1, a dental analog 1 according to the invention is shown in an oblique view. The dental analog 1 comprises an installation section 2 and an interface section 3 located opposite to the installation section 2. The installation section 2 serves the purpose that the dental analog 1 can be inserted into a 3D model (see also FIGS. 5a, 5b). For this, the end section 12 is provided, which is introduced into an opening in the 3D model.

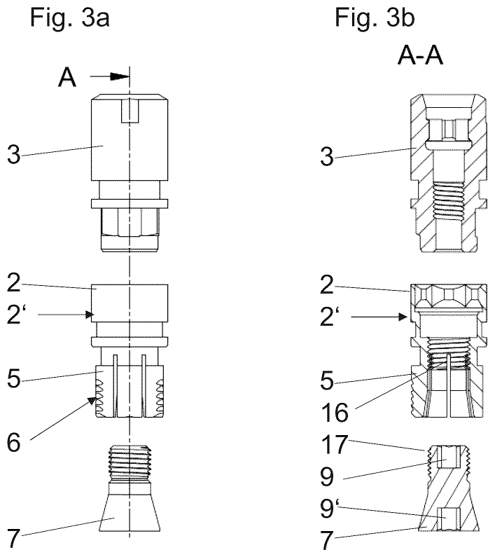

In the exemplary embodiment as shown, the installation section 2 has a locking section 4 which can be inserted into a suitable opening in a 3D model. In the exemplary embodiment as shown, the dental analog 1 has a multi-part design, with the installation section 2 and the interface section 3 having a detachable connection, which is explained in further detail below with reference to FIGS. 3a and 3b.

The locking section 4 of the installation section 2 has several expansion elements 5. On the expansion elements 5, knobs 6 are additionally placed, which improve the fit (slip resistance) of the dental analog 1 in the 3D model. In the exemplary embodiment as shown, the expansion elements 5 are pivoted in. In this state, the locking section 4 with the expansion elements 5 pivoted in thus has a cylindrical shape, for example.

Furthermore, a locking element 7 is provided, by means of which the expansion elements 5 can be pivoted out of the locking section 4 in order to anchor the installation section 2 in the 3D model. For later removal of the installation section 2 or, respectively, the dental analog 1 from the 3D model, the expansion elements 5 are re-pivoted in. For this purpose, the locking element 7 comprises shaped elements 9, 9′, which can be actuated with a tool.

The shaped element 9′ shown in FIG. 1 is designed as an internal hexalobular feature and can be actuated in the axial direction from the side of the end section 12. For this purpose, for example, a screwdriver with an appropriate external hexalobular tip can engage the shaped element 9′. Of course, the shaped element 9 can have other shapes, such as, e.g., a hexagon socket, etc., so that the tool must have the complementary shape (e.g., an external hexagon tip).

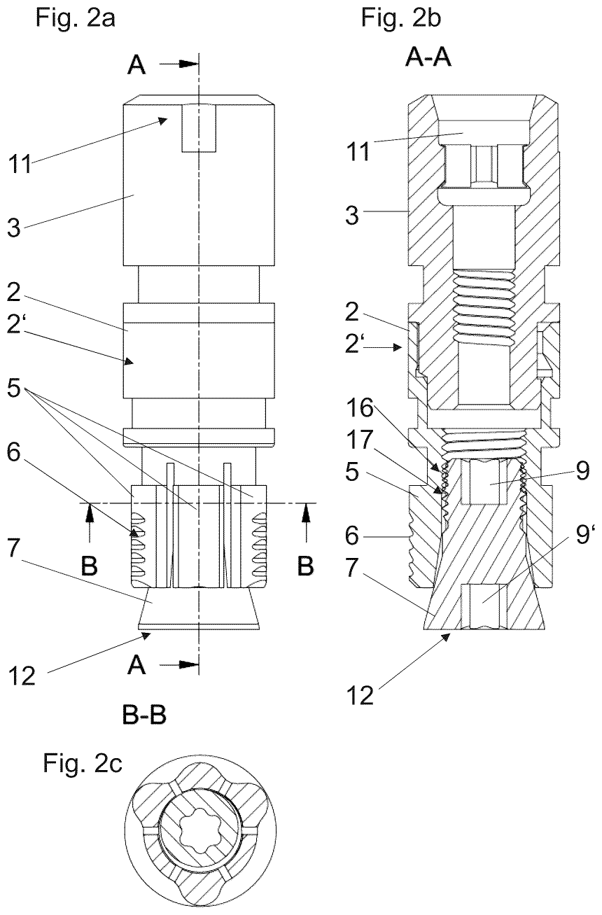

The mode of operation of the locking element 7 can be explained more precisely on the basis of the views in FIGS. 2a and 2b. The locking element 7 has a screw section 17 in the form of an external thread on the locking element 7. The screw section 17 is arranged on the outer surface above a frustoconical or, respectively, wedge-shaped section of the locking element 7. A corresponding threaded section 16 in the form of an internal thread is arranged on the inside of the installation section 2. By moving the locking element 7 upwards, the wedge-shaped section of the locking element 7 can be moved in the axial direction A of the dental analog 1 relative to the installation section 2.

In addition to the shaped element 9′ already explained with reference to FIG. 1, the locking element 7 has another shaped element 9 which can be actuated in the axial direction from the side of the interface section 2. The mode of operation of both shaped elements 9, 9′ is identical. Two shaped elements 9, 9′ do not have to be provided, only one can also be present or accessible, respectively.

By means of a tool (e.g., a screwdriver with a shape that is complementary to the shaped elements 9, 9′), the locking element 7 functions like a clamping screw in a mandrel. Due to this relative movement of the locking element 7 across the screw section 17 and the corresponding threaded section 16, the expansion elements 5 are moved outwards in the manner of a mandrel.

The expansion elements 5 can be pivoted out radially along the longitudinal axis of the installation section 2. In the pivoted-out state, the expansion elements 5 thereby form a truncated cone, for example. In this case, the top surface of the truncated cone is closer to the interface section 3 than the base surface of the truncated cone.

A positive and non-positive connection is provided between the installation section 2 and the interface section 3 in order to stably connect the interface section 3 to the installation section 2 that has already been firmly anchored. The accuracy of fit of the final treatment with implant structures can thus be checked on the model. To distinguish between the different diameters, the analogs are also available with different colourings.

The interface section 3 can have—as in the example shown—a connection point 11 for an abutment (not shown). The abutment can be attached by a screw cap.

At least in the region 2′ of the largest diameter of the installation section 2, the installation section 2 has a cylindrical (herein a circular cylindrical) design.

In FIGS. 3a and 3b, the mode of operation of the locking element 7, which has been explained with reference to FIGS. 2a and 2b, can be seen even more clearly. The locking element 7 is screwed into the corresponding threaded section 16 via the screw section 17. Furthermore, the multi-part design of the dental analog 1 is illustrated, in which the interface section 3 is coupled to the installation section 2 via a non-positive connection. The connection point 11 for an abutment can be seen in the interface section 3.

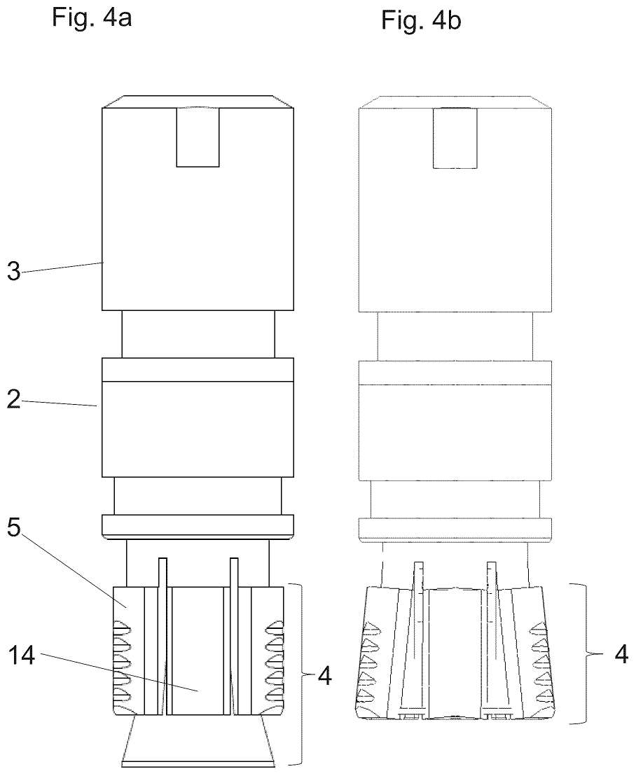

FIGS. 4a and 4b show the dental analog 1 in the unlocked (FIG. 4a) and in the locked (FIG. 4b) states. Due to the movement of the locking element 7 relative to the dental analog 1, the locking element is moved underneath the expansion elements 5, when locking takes place. The expansion elements 5 are pushed outwards by the wedge-shaped section.

FIGS. 5a and 5b show the dental analog 1 inserted into a 3D model, with the area 20 of the 3D model surrounding the dental analog 1 also being shown. It is evident that the interface section 3 is also inserted to a large extent into the 3D model, and only a very small part of the dental analog 1 protrudes from the 3D model.

In addition, the sectional view in FIG. 5b shows the indexing 14, which engages a corresponding groove 21 in the area 20 surrounding the dental analog 1. A total of three expansion elements 5 are shown, and the index 14 is visible in the form of a projection between two expansion elements 5.

In addition to the shaped element 9′ already explained with reference to FIG. 1, the locking element 7 has another shaped element 9 which can be actuated in the axial direction from the side of the interface section 3. The mode of operation of both shaped elements 9, 9′ is identical. Two shaped elements 9, 9′ do not have to be provided, only one can also be present or accessible, respectively.

By means of a tool (e.g., a screwdriver with a shape that is complementary to the shaped elements 9, 9′), the locking element 7 functions like a clamping screw in a mandrel. Due to this relative movement of the locking element 7 across the screw section 17 and the corresponding threaded section 16, the expansion elements 5 are moved outwards in the manner of a mandrel.

The expansion elements 5 can be pivoted out radially along the longitudinal axis A of the installation section 2. In the pivoted-out state, the expansion elements 5 thereby form a truncated cone, for example. In this case, the top surface of the truncated cone is closer to the interface section 3 than the base surface of the truncated cone.

A positive and non-positive connection is provided between the installation section 2 and the interface section 3 in order to stably connect the interface section 3 to the installation section 2 that has already been firmly anchored. The accuracy of fit of the final treatment with implant structures can thus be checked on the model. To distinguish between the different diameters, the analogs are also available with different colourings.

The interface section 3 can have—as in the example shown—a connection point 11 for an abutment (not shown). The abutment can be attached by a screw cap.

1. A dental analog comprising
an installation section and an interface section located opposite to the installation section,
with the installation section comprising an end section for inserting the dental analog into a cavity of a 3D model, wherein the installation section comprises a locking section with expansion elements,
wherein a locking element is provided, by means of which the expansion elements are pivotable out of the locking section and pivotable into the locking section.

2. The dental analog according to claim 1, wherein, at least in the region of the largest diameter of the installation section, the installation section has a cylindrical design, preferably a circular cylindrical design.

3. The dental analog according to claim 1, wherein the locking element has a cylindrical design in the state with the expansion elements pivoted in.

4. The dental analog according to claim 1, wherein the locking element can be actuated in the axial direction from the side of the interface section via a shaped element.

5. The dental analog according to claim 1, wherein the locking element can be actuated in the axial direction from the side opposite the interface section via a shaped element.

6. The dental analog according to claim 1, wherein the locking element comprises a screw section, and the installation section comprises a threaded section corresponding to the screw section, wherein the locking element is movable in the axial direction of the dental analog relative to the installation section by actuating the shaped element.

7. The dental analog according to claim 1, wherein the expansion elements can be pivoted out radially along the longitudinal axis of the installation section.

8. The dental analog according to claim 1, wherein the expansion elements, in the pivoted-out state, form, for example, a truncated cone, with the top surface of the truncated cone being arranged closer to the interface section than the base surface of the truncated cone.

9. The dental analog according to claim 1, wherein the installation section and the interface section are connected to each other via a preferably detachable connection.

10. The dental analog according to claim 9, wherein the detachable connection between the installation section and the interface section is configured in a positive way.

11. The dental analog according to claim 9, wherein the detachable connection between the installation section and the opposite interface section is configured in a non-positive way.

12. The dental analog according to claim 1, wherein the interface section has a connection point for an abutment or a dental crown.

13. The dental analog according to claim 1, characterized in the installation section has one or several indexes.

14. A method of producing a dental prosthesis for a set of teeth, comprising operations including:
(i) creating a 3D model of the set of teeth,
(ii) incorporating an opening in the 3D model in the area in which an implant for the dental prosthesis is provided in the set of teeth,
(iii) introducing the installation section of a dental analog according to claim 1 into the opening and locking the dental analog by actuating the locking element,
(iv) inserting an unprocessed dental crown into the interface section, with an abutment optionally being inserted beforehand between the interface section and the unprocessed dental crown,
(v) modelling the unprocessed dental crown to form the desired dental prosthesis, and
(vi) removing the finished dental prosthesis.

15. A use of a dental analog according to claim 1 in a 3D model of a set of teeth.
